(19) United States
(12) Patent Application Publication
(10) Pub. No.: US 2011/0029950 A1
(43) Pub. Date: Feb. 3, 2011

(54) COMPUTER-READABLE MEDIA, METHODS AND COMPUTER SYSTEMS FOR DESIGNING A SOFTWARE APPLICATION GRAPHICALLY

(76) Inventors: Iftach RAGOLER, Givat Brenner (IL); Adi BARDA, Holon (IL); Ran LAMPERT, Rishon Le Zion (IL)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/512,739

(22) Filed: Jul. 30, 2009

(51) Int. Cl. G06F 9/44

(52) U.S. Cl. 717/109; 717/129

(57) ABSTRACT

Computer-readable media, methods and computer systems for designing a software application graphically are provided herein. Designing a software application graphically may include inserting a graphical link between parameters of graphical nodes representing first and second activities of a software application, the graphical link representing a data control link that includes an adjustable state, and forming a computer-generated executable with the first and second activities, the data link and the adjustable state.

### BACKGROUND

As software applications become more complex, designers are distributing the applications among multiple computer systems, rather than designing applications to run on a single computer. For example, Service Oriented Architecture (“SOA”) is a software design model where software applications are separated into distinct services. These services often are distributed among multiple computers and are configured to exchange messages. Distributed applications often are formed at least in part from these distributed services.

Visual design applications are used to design software applications graphically. However, existing visual design applications have interfaces that are ill-suited for designing and testing distributed applications, such as SOA applications. For example, in existing design applications, users manually input at least some computer code. Many existing applications also fail to present data flow between distributed services of a software application. Even applications that attempt to present data flow do it in ways that are unintuitive and difficult to comprehend.

### BRIEF DESCRIPTION OF THE DRAWINGS

FIG. 1 is a schematic view of a graphical user interface (“GUI”) for creating and testing computer applications, according to an embodiment of the disclosure.

FIG. 2 depicts a first activity with multiple output parameters that are linked to multiple input parameters of a second activity using multiple graphical links, according to an embodiment of the disclosure.

FIG. 3 depicts a distributed application with a graphical link selected, according to an embodiment of the disclosure.

FIG. 4 depicts an interface according to an embodiment of the disclosure that provides for modification of a state of the data link represented by the graphical link that is selected in FIG. 3.

FIG. 5 depicts an executed distributed application as executed to show the execution path, according to an embodiment of the disclosure.

FIG. 6 depicts a method of designing and testing a software application graphically in accordance with an embodiment of the disclosure.

### DETAILED DESCRIPTION

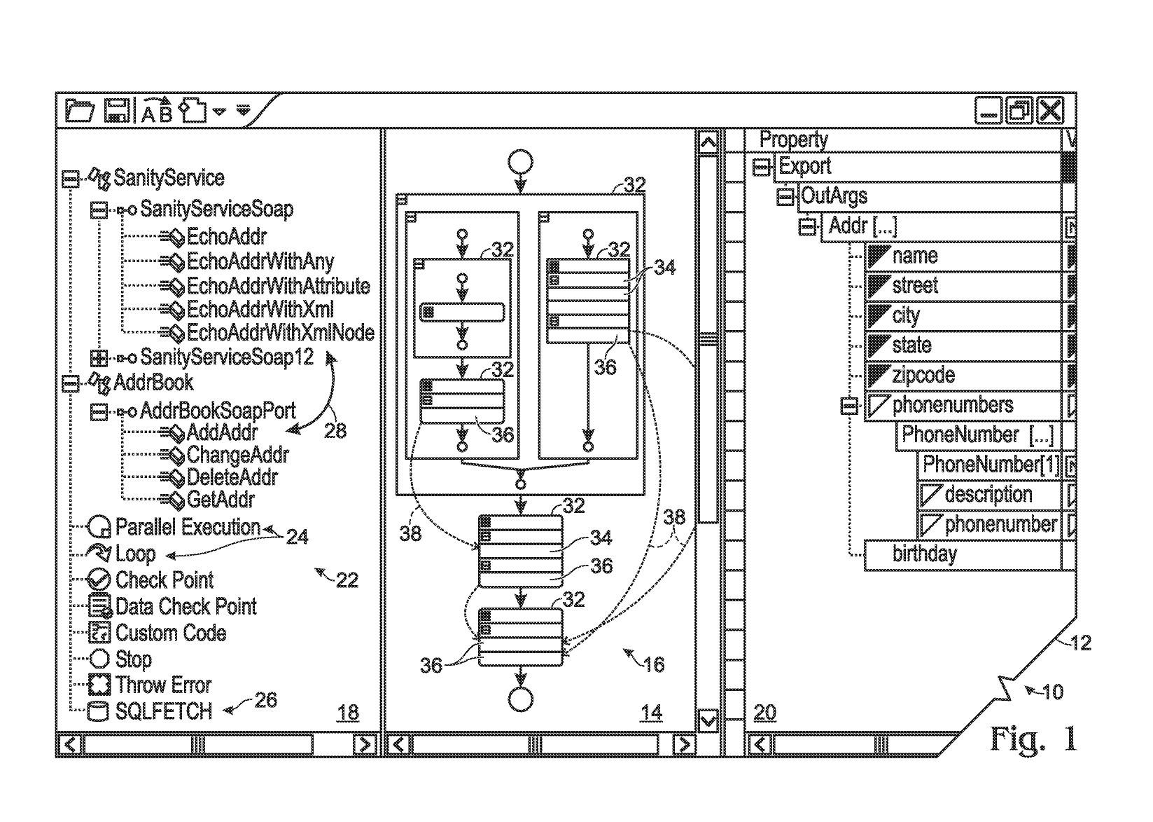

FIG. 1 depicts a design and testing application 10 that is operable with an associated GUI 12 to design a software application. GUI 12 includes a test design area 14 configured to receive components (e.g., by dragging and dropping) to form a graphical depiction 16 of the software application being designed. GUI 12 also includes a toolbox area 18 and a property area 20.

Components of a software application may include activities and data links between input/output parameters of activities. A list of activities 22 is shown in toolbox area 18 of GUI 12. Example of activities include flow control activities 24, built-in activities 26, services 28 (e.g., SOA, web services) and composite activities.

Flow control activities 22 direct the logic and flow of a software application. Examples of control flow activities include branching, if/else statements, terminate, error-throwing and catching functions, loops and parallel execution. Built-in activities perform common operations and typically are included with design and testing application 10. Examples of built-in activities 24 include database queries, web requests, file comparisons and security functions (e.g., RADIUS call).

Services 26 may be any number of distributable activities, such as SOA services and/or web services. Services 26 may be loaded dynamically into the design and testing application 10 by, for example, parsing a metadata file (e.g., a Web Service Definition Language (“WSDL”)) file to extract operations contained therein. A separate activity may be created for each extracted operation.

Composite activities are “black boxes” that encapsulate two or more activities and data links between those activities into a single activity. Composite activities aid in the creation of complex software applications by allowing large portions of a software application to be reused as parts of different software applications.

As noted above, activities and data links may be inserted onto test design area 14 to create a graphical depiction 16 of a software application. For example, in a GUI 12 such as the one depicted in FIG. 1, activities from the list of activities 22 may be dragged onto test design area 14 so that graphical nodes 32 representing each activity are displayed. Each activity may include input parameters (indicated at 34) and output parameters (indicated at 36) that are represented graphically on the graphical nodes 32.

Once two or more graphical nodes 32 representing activities are inserted onto test design area 14, a graphical link 38 representing a data link may be inserted to extend between parameters of the activities. For example, a user may click on an output parameter 36 of a first activity and drag a cursor to an input parameter 34 of a second activity to create a graphical 38 link between the two. In this manner, data output from the first activity is passed as input to the second activity. In some embodiments, a user may click on an output parameter 36 of a first activity and drag a cursor to an output parameter 36 of a second activity to create a graphical 38 link between the two. In this manner, data output from the second activity is replaced with output from the first activity.

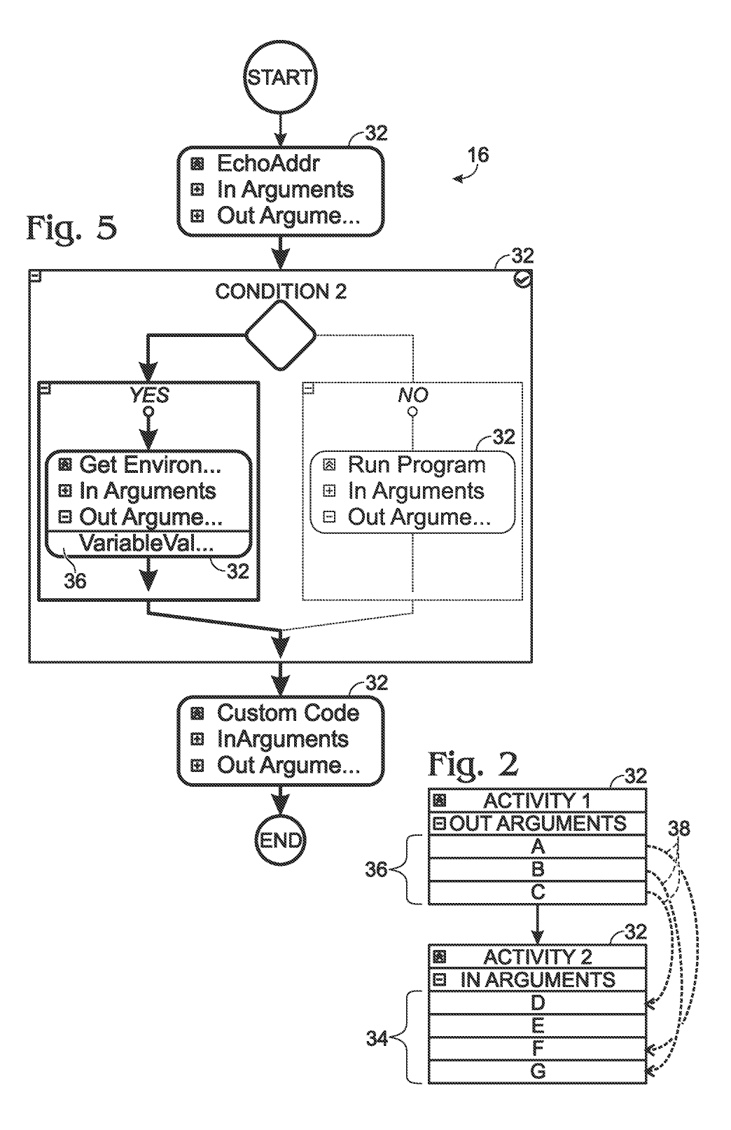

In FIG. 2, two graphical nodes 32 representing activities are shown connected by graphical links 38 representing data links. ACTIVITY 1 includes three output parameters and ACTIVITY 2 includes four input parameters. Using graphical links 38, the three output parameters from ACTIVITY 1 are mapped to three of the four input parameters of ACTIVITY 2. Although ACTIVITY 2 immediately follows ACTIVITY 1 in this example, it should be understood that graphical links may be extended between parameters of activities that are not immediately adjacent each other in the flow of the application. Such an example is shown in FIG. 1.

Property area 20 may be used to edit properties of activities and data links. In the case of activities, a user may select a graphical node representing an activity (e.g., by clicking on it with a mouse) and the selected activity's properties will appear in property area 20, as shown in FIG. 1. The selected activity's properties may include characteristics of its input and output parameters, such as their internal components, as well as other information. Additionally and as will be discussed below, an activity may be fed multiple datasets for running various test cases by editing the activity's properties.

In the case of data links, a user may select a graphical link (e.g., by clicking on it with a mouse) representing a data link, and the selected data link's properties will appear in property area 20. Each data link may have an adjustable state that may be edited in property area 20. A data link's adjustable state may map internal elements of output and input parameters, transform data types between output and input parameters, and include custom coded events.

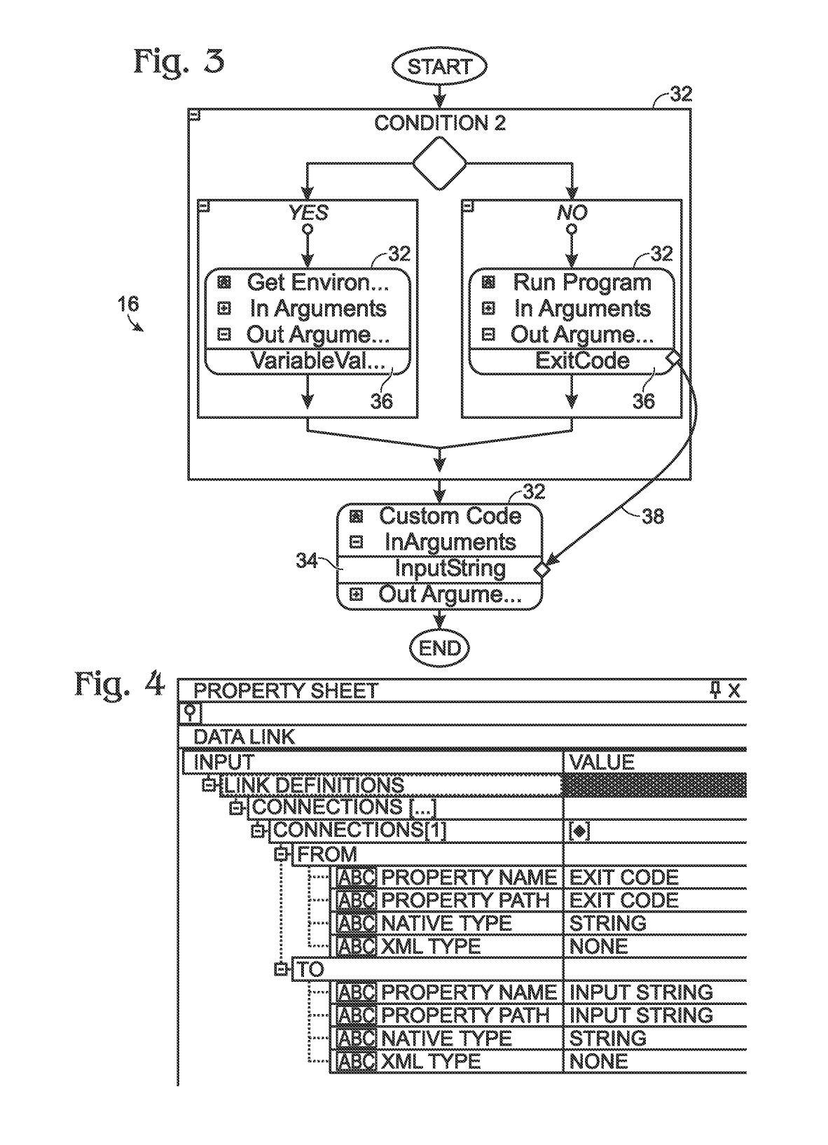

In FIG. 3, a graphical link 38 that extends between the “ExitCode” output parameter of the “Run Program” activity and the “InputString” input parameter of the “Custom Code” activity is selected. Properties area 20, as it would appear upon selecting graphical link 38 in FIG. 3, is shown in FIG. 4 and provides for editing of the data link's adjustable state. A “Connections” category includes mappings between the output parameter (ExitCode) and the input parameter (InputString). In this example, ExitCode and InputString both are native strings, and so the connection between the two includes basic information like the property name. However, more complex data types may be passed using data links. For example, an output parameter may be a complex data type that includes multiple internal elements (e.g., fields of a web service call). In some embodiments, complex data types may be formed as XML of various formats (e.g., WSDL, SOAP). Internal elements of such a complex output parameter may be mapped to internal elements of a complex input parameter in a data link's adjustable state. For example, a data link's adjustable state could be edited to include the following:

OutArg/Customer/Addresses/Address

mapped to InArg/Purchaser/PhoneNumber)

OutArg/Customer/Addresses/PhoneNumber

mapped to InArg/Purchaser/PhoneNumber)

Additionally, a data link's adjustable state may transform a data type of data passed from one activity to another. For example, a first activity's output parameter (or an internal element thereof) that is an integer may be mapped to a second activity's input parameter (or an internal element thereof) that is meant to receive a float value. Rather than inserting an additional activity in between the first and second activities that transforms the integer to float, the graphical link 38 representing the data link may be selected, and its adjustable state may be adjusted so that integer values output from the first activity are transformed to float values before being used as input for the second activity.

Additionally or alternatively, a data link's adjustable state may be tied to an event. In some embodiments, a user may create custom code that may be formed into an event. The event may then be executed as data is passed between parameters of activities. For example, when a lengthy string (e.g., the text of an article) is passed through a data link between a first activity and a second activity, an event may be thrown that causes a substring (e.g., an excerpt from the article) that matches a criterion to be extracted from output of the first activity, so that it may be used as input for the second activity.

Once a graphical depiction 16 of a complete software application is formed in design area 14, design application 10 may form a computer-generated executable that includes these components. The executable may be formed automatically or at the request of a user. In some embodiments, human-readable source code is generated based on the activities, the data link, and the relationships between these components, and then compiled into an executable.

Once a computer-generated executable is formed, a designer/tester may test the executable by executing it within the context of GUI 12. A path may be indicated visually in the graphical depiction 16 of the software application that traverses the graphical nodes representing the activities that were executed. In some embodiments, the graphical nodes are highlighted in a color that contrasts with a background color of test design area 14. In this manner, a user can look at the graphical depiction 16 to determine how software application performed when used on particular data.

For example, FIG. 5 depicts a graphical representation 16 of a software application after execution. The activities EchoAddr, Get Environment and Custom Code are highlighted, indicating that the executed path traversed these activities. Likewise, the activity Run Program, which is to be performed if a condition 44 returns “No,” is shown un-highlighted and in a lighter shade, to indicate that this path was not followed.

Additional testing features may be provided. For example, a checkpoint may be set at parameters of activities. A datum then may be tested against a criterion at a stage of the computer-generated executable corresponding to the checkpoint. A checkpoint allows a designer or tester to test a value passed to/from a parameter against any number of conditions (e.g., greater/less than, equals, regular expressions). In some embodiments, a parameter (34 or 36) of an activity 38 may be set as a checkpoint using property area 20.

Additionally, a designer/tester may test the computer-generated executable, as well as any of the individual activities that form the executable, with one or more data sets. For example, if an activity has 3 input parameters (e.g., integer, float, string), a tester may define multiple datasets (e.g., {2, 54.0, “difference”}, {56, 3.1, “dividend”}, {99999, 0.00, “boundaries”}) that are used sequentially as input for the activity.

In some embodiments, an activity and/or a parameter thereof may be linked to an outside data source. A user may populate a spreadsheet or database table with one or more sets of test data. The user then may connect an activity or a parameter thereof to the spreadsheet or database table so that the activity iterates through each set of test data. In some instances, this data handling may be encapsulated within a “Data Fetch” activity, which may be represented graphically in a manner similar to other activities, and may be linked to parameters of other activities using graphical links as described above.

When testing loops or other repeating control flow activities, some embodiments may include a “Cursor” activity. A “Cursor” activity may be linked to a “Data Fetch” activity on one end and to a parameter of an activity within a loop on the other end. Thus, the “Cursor” activity, through its connection to an outside data source via the “Data Fetch” activity, may iterate through each of a plurality of data sets in the outside data source.

In addition to iterating through multiple data sets, “Data Fetch” activities also may be used to populate multiple internal elements of parameters of activities. Assume, for example, that an activity is a web service that has an input parameter configured to receive a complex data type (i.e., has multiple internal elements) as input. A user may drag and extend a data link between that parameter and a “Data Fetch” activity that is connected to an outside spreadsheet. The outside spreadsheet has multiple cells, each containing pieces of information that may be usable for each internal element of the input parameter of the web service. A user then may edit the state of the data link between the “Data Fetch” activity and the input parameter of the web service to map information in various cells of the spreadsheet to internal components of the parameter.

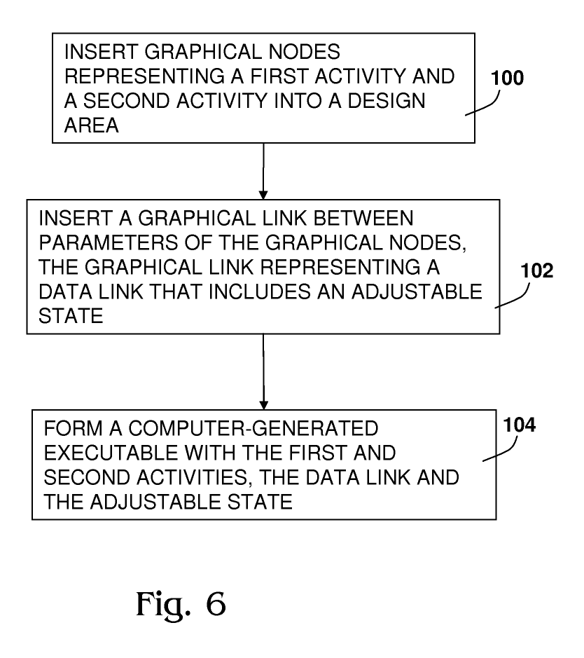

FIG. 6 depicts a method of designing graphically a software application in accordance with an embodiment of the disclosure. In step 100, a user inserts graphical nodes 32 representing first and second activities into a design area of a GUI, e.g., by dragging and dropping activities from toolbox area 18 to test design area 14.

In step 102, the user inserts a graphical link 38 into the design area between parameters (e.g., 34, 36) of the graphical nodes 32. The graphical link represents a data control link that includes an adjustable state. Steps 100 and 102 may be repeated until a graphical depiction 16 of a complete software application is formed in test design area 14.

Once a graphical representation 16 of a complete software application is created in design area 14, a computer-generated executable may be formed in step 104, using the first and second activities, the data link and the adjustable state of the data link. This executable may be executed within the context of GUI 12 or in some cases independently of GUI 12.

The disclosure set forth above may encompass multiple distinct embodiments with independent utility. The specific embodiments disclosed and illustrated herein are not to be considered in a limiting sense, because numerous variations are possible. The subject matter of this disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether directed to a different invention or to the same invention, and whether broader, narrower, equal, or different in scope to the original claims, also are regarded as included within the subject matter of the inventions of the present disclosure.

Where the claims recite “a” or “a first” element or the equivalent thereof, such claims include one or more such elements, neither requiring nor excluding two or more such elements. Further, ordinal indicators, such as first, second or third, for identified elements are used to distinguish between the elements, and do not indicate a required or limited number of such elements, and do not indicate a particular position or order of such elements unless otherwise specifically stated.

What is claimed is:

1. A computer-readable medium having computer-executable instructions for designing a software application graphically, the instructions causing a computer to perform steps comprising:
inserting graphical nodes representing first and second activities of a software application into a design area;
inserting a graphical link between parameters of the graphical nodes, the graphical link representing a data link that includes an adjustable state; and
forming a computer-generated executable with the first and second activities, the data link and the adjustable state.

2. The computer-readable medium of claim 1, wherein inserting the graphical link includes extending the graphical link from an output parameter of the first activity to an input parameter of the second activity so that data output from the first activity is passed as input to the second activity.

3. The computer-readable medium of claim 2, wherein at least one of the first and second activities is a web service.

4. The computer-readable medium of claim 2, wherein the adjustable state maps internal elements from the output parameter of the first activity to internal elements of the input parameter of the second activity.

5. The computer-readable medium of claim 1, wherein the adjustable state includes a custom-coded event.

6. The computer-readable medium of claim 2, wherein the adjustable state transforms data from the output parameter from a first data type to a second data type.

7. The computer-readable medium of claim 1, further including executable instructions for causing the computer to perform steps comprising:
executing the computer-generated executable; and
indicating visually a path along the graphical nodes representing the first and second activities.

8. The computer-readable medium of claim 7, further including executable instructions for causing the computer to perform steps comprising:
inserting a visual checkpoint among the graphical nodes and the graphical link; and
testing a datum against a criterion at a stage of the computer-generated executable corresponding to the visual checkpoint.

9. The computer-readable medium of claim 7, wherein indicating visually includes highlighting the graphical nodes in a color that contrasts with a background color of a design area upon which the graphical nodes representing the first and second activities are displayed.

10. The computer-readable medium of claim 7, further including executable instructions for causing the computer to perform steps comprising:
receiving a plurality of datasets at one of the first and second activities;
automatically executing the computer-generated executable once for each dataset of the plurality of datasets.

11. The computer-readable medium of claim 2, further including executable instructions for causing the computer to insert a second graphical link between a second output parameter of the first activity and a second input parameter of the second activity, the second graphical link representing a second data link that includes a second adjustable state.

12. A method of designing a software application graphically, comprising:
inserting graphical nodes representing first and second activities of the software application into a design area of a graphical user interface;
inserting a graphical link into the design area to link an output parameter of a first activity to an input parameter of a second activity, the graphical link representing a data link that includes an adjustable state; and
forming a computer-generated executable with the first and second activities, the data link and the adjustable state.

13. The method of claim 12, wherein the adjustable state maps internal elements from output parameter of the first activity to internal elements of the input parameter of the second activity.

14. The method of claim 12, further comprising:
executing the computer-generated executable; and
indicating visually a path along the graphical nodes representing the first and second activities.

15. A computer system for designing a software application graphically, comprising:
means for inserting graphical nodes representing a first activity and a second activity of the software application into a design area of a graphical user interface;
means for inserting into the design area a graphical link from an output parameter of the first activity to an input parameter of the second activity, wherein the graphical link represents a data link that includes an adjustable state; and
means for forming a computer-generated executable application with the first and second activities, the data link and the adjustable state.

16. The computer system of claim 15, wherein at least one of the first and second activities is a web service.

17. The computer system of claim 15, wherein the adjustable state maps internal elements from the output parameter of the first activity to internal elements of the input parameter of the second activity.

18. The computer system of claim 15, wherein the data control link includes a transformation from a first data type to a second data type.

19. The computer system of claim 15, further including:
means for executing the computer-generated executable; and
means for indicating visually a path along the graphical nodes representing the first and second activities.

20. The computer system of claim 15, further comprising:
means for receiving a plurality of datasets at one of the first and second activities;
means for automatically executing the computer-generated executable once for each dataset of the plurality of datasets.
